(19) United States
(12) Patent Application Publication
(10) Pub. No.: US 2023/0331595 A1
(43) Pub. Date: Oct. 19, 2023

(54) System and Method for Electrochemical Oxidation of Polyfluoroalkyl Substances in Water

(71) Applicant: Evoqua Water Technologies LLC, Pittsburgh, PA (US)

(72) Inventors: Yang Chen, Lowell, CA (US); Simon P. Dukes, Chelmsford, MA (US)

(73) Assignee: Evoqua Water Technologies LLC, Pittsburgh, PA (US)

(21) Appl. No.: 17/270,852

(22) PCT Filed: Aug. 23, 2019
(86) PCT No.: PCT/US2019/047922

§ 371 Date: Feb. 23, 2021

Related U.S. Application Data
(60) Provisional application No. 62/721,647, filed on Aug. 23, 2018.

(51) Int. Cl. C02F 1/467; C02F 1/00; C02F 1/461

(52) U.S. Cl. CPC C02F 1/4672; C02F 1/008; C02F 1/46109; C02F 2101/36

(57) ABSTRACT

Electrochemical treatment for the removal of poly- and perfluorolkyl substances from water is disclosed. An electrochemical cell may include a Magnéli phase titanium oxide electrode.

### CROSS-REFERENCE TO RELATED APPLICATION

This application claims the benefit of priority to U.S. Provisional Patent Application Ser. No. 62/721,647 as filed on Aug. 23, 2018 and titled “SYSTEM AND METHOD FOR ELECTROCHEMICAL OXIDATION OF POLYFLUOROALKYL SUBSTANCES IN WATER,” the entire disclosure of which is hereby incorporated herein by reference in its entirety for all purposes.

### FIELD OF THE TECHNOLOGY

One or more aspects relate generally to electrochemical water treatment.

### BACKGROUND

Per- and polyfluoroalkyl substances (PFAS) are organic compounds consisting of fluorine, carbon and heteroatoms such as oxygen, nitrogen and sulfur. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

Sorption or filtration technologies have been commonly used to separate PFAS from impacted water (including wastewater, surface water, drinking water, and groundwater). Separation via sorbents or filters relies on sorption and other physical mechanisms that remove PFAS from water. The sorbents or filters (including ion exchange resin, reverse osmosis filters and activated carbon filters) will eventually become loaded with high concentrations of PFAS requiring regeneration of the sorbents or filters if they cannot be safely discharged or disposed of by other means.

### SUMMARY

In accordance with one or more aspects, a method of treating water containing per- and polyfluoroalkyl substances (PFASs) is disclosed. The method may comprise introducing the water to an electrochemical cell comprising a cathode and a Magnéli phase titanium oxide anode having a porosity of at least about 25%, and applying a voltage to the anode in an amount sufficient to promote oxidation of the PFASs in order to produce treated water.

In some aspects, the PFASs may comprise perfluorooctane sulfonic acid (PFOS) or perfluorooctanoic acid (PFOA).

In some aspects, the anode may comprise TiₙO₂ₙ₋₁, where n ranges from 3 to 9 inclusive. In some specific aspects, the anode may comprise Ti₄O₇. The anode may comprise a mesh structure. The anode may comprise a foam structure. A foam anode may be characterized by a mean pore size of from about 100 μm to about 2 mm. The cathode may be made of a stainless steel, nickel alloy, titanium, or a dimensionally stable anode (DSA) material.

In some aspects, the water is circulated between the cathode and the anode. In other aspects, the water may be circulated through the anode and cathode in series.

In some aspects, the electrochemical cell may comprise a sodium sulfate electrolyte, e.g. a sodium sulfate electrolyte at a concentration of about 5 mM.

In some aspects, the method may further comprise introducing the treated water to a downstream unit operation for further treatment. The method may further comprise monitoring a PFAS concentration, pH level, or other operational parameter upstream of the electrochemical cell. The method may further comprise adjusting the applied voltage in response to the monitored PFAS concentration. The method may further comprise monitoring a PFAS concentration, pH level, or other operational parameter downstream of the electrochemical cell.

In accordance with one or more aspects, a water treatment system is disclosed. The system may comprise an electrochemical cell comprising a Magnéli phase titanium oxide anode having a porosity of at least about 25%, and a source of water comprising PFASs fluidly connected to an inlet of the electrochemical cell.

In some aspects, the PFASs may comprise perfluorooctane sulfonic acid (PFOS) or perfluorooctanoic acid (PFOA). The anode may comprise Ti₄O₇. The anode may comprise a mesh structure. The anode may comprise a foam structure. A foam anode may be characterized by a mean pore size of from about 100 μm to about 2 mm.

In some aspects, the electrochemical cell may be constructed and arranged to circulate the water between the cathode and the anode. The electrochemical cell may be constructed and arranged to circulate the water through the cathode and the anode in series.

In some aspects, the electrochemical cell may further comprise a sodium sulfate electrolyte, e.g. a sodium sulfate electrolyte at a concentration of about 5 mM.

In some aspects, the system may further comprise at least one concentration, pH, voltage, or other sensor positioned upstream and/or downstream of the electrochemical cell. The system may further comprise a controller in communication with the at least one sensor configured to adjust a voltage applied to the electrochemical cell.

In some aspects, the anode of the electrochemical cell may be characterized by a hydrophobic surface.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

Certain illustrative features and examples are described below with reference to the accompanying figures in which:

FIG. 1 illustrates oxygen overpotential of an anode material in accordance with one or more embodiments;

FIG. 2A presents a schematic of a flow between electrodes (FBE) electrochemical cell arrangement in accordance with one or more embodiments; and

FIG. 2B presents a schematic of a flow through electrodes (FTE) electrochemical cell arrangement in accordance with one or more embodiments.

It will be recognized by the person of ordinary skill in the art, given the benefit of this disclosure, that the figures are purely for illustrative purposes. Other features may be present in the embodiments disclosed herein without departing from the scope of the description.

### DETAILED DESCRIPTION

In accordance with one or more embodiments, systems and methods relate to electrochemical treatment of water. In some embodiments, electrochemistry may be applied for the removal of various negatively-charged contaminant molecules. Notable amongst such molecules are per- and polyfluoroalkyl substances (PFASs), also referred to as perfluorinated chemicals (PFCs), that are present in wastewater. These man-made chemical compounds are very stable and resilient to breakdown in the environment. They may also be highly water soluble because they carry a negative charge when dissolved. They were developed and widely used as a repellant and protective coating. Though they have now largely been phased out, elevated levels are still widespread. For example, water contaminated with PFAS or PFC may be found in industrial communities where they were manufactured or used, as well as near airfields or military bases where firefighting drills were conducted. PFAS or PFC may also be found in remote locations via water or air migration. Many municipal water systems are undergoing aggressive testing and treatment. This invention is not limited to the types of negatively-charged and/or fluorinated compounds being treated.

In some non-limiting embodiments, electrochemical techniques may be applied for the destruction of PFASs in water. In some embodiments, cationic PFAS of PFC levels in water may be addressed. In some specific non-limiting embodiments, common PFCs such as perfluorooctanoic acid (PFOA) and/or perfluorooctane sulfonic acid (PFOS) may be removed from water via an electrochemical operation. The U.S. Environmental Protection Agency (EPA) developed revised guidelines in May 2016 of a combined lifetime exposure of 70 parts per trillion (PPT) for PFOS and PFOA. Federal, state, and/or private bodies may also issue relevant regulations. In some embodiments, other approaches for PFC removal, such as the use of ion exchange resin, may be used in conjunction with electrochemical treatment as described herein.

In accordance with one or more embodiments, product water as described herein may be potable. In at least some embodiments, electrochemical treatment as described herein may find utility in the municipal water treatment market and may be used to produce drinking water. The disclosed techniques may be integrated with one or more pre- or post-treatment unit operations. For example, an electrochemical cell may be used in conjunction with another water treatment approach such as ion exchange.

In accordance with one or more embodiments, an electrochemical cell may be used to degrade PFASs in water. The electrochemical cell may generally include two electrodes, a cathode and an anode. A reference electrode may also be used, for example, in proximity to the anode.

In accordance with one or more embodiments, the cathode may be constructed of various materials. Environmental conditions, e.g. pH level, and specific process requirements, e.g. those pertaining to cleaning or maintenance, may impact cathode selection. In some non-limiting embodiments, the cathode may be made of stainless steel, nickel alloy, titanium, or a dimensionally stable anode (DSA) material.

In accordance with one or more embodiments, the anode may be constructed of a material characterized by a high oxygen overpotential. Overpotential may generally relate to the potential difference (voltage) between a half-reaction's thermodynamically determined reduction potential and the potential at which a redox event is experimentally observed. The term may be directly related to an electrochemical cell's voltage efficiency.

In accordance with one or more embodiments, the anode may exhibit a preference for a surface reaction in water. Based on various physical characteristics and/or the chemical composition of the anode, water molecules may be repelled from the surface while non-polar organic pollutants may be easily absorbed. This may promote a direct oxidation reaction on the surface which may, for example, be particularly beneficial for the treatment of PFASs.

In accordance with one or more embodiments, the anode may be constructed of a Magnéli phase titanium oxide. Magnéli phase titanium oxide anodes may have superior performance towards oxygen evolution compared to other anodes. This may allow for the direct oxidation of PFASs on its surface. Additionally, in comparison to other electrodes with similar overpotential characteristics, Magnéli phase titanium oxide is less expensive than boron doped diamond (BDD), more robust than Ti/SnO₂, and more environmentally friendly than Pb/PbO₂.

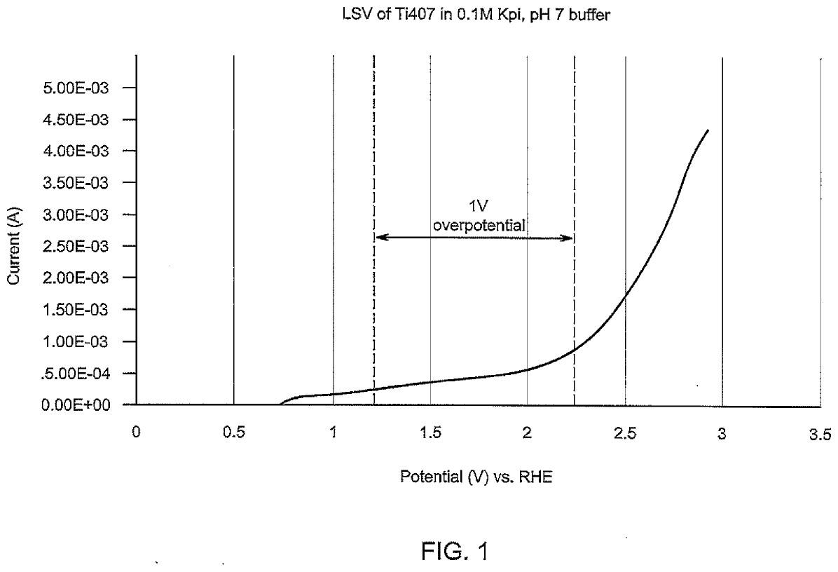

In some embodiments, the anode material may generally have the formula TiₙO₂ₙ₋₁, where n ranges from 3 to 9 inclusive. In some specific non-limiting embodiments, the anode may be made of Ti₄O₇. Pure Ti₄O₇ may be an attractive material for the application of advanced electrochemical oxidation. FIG. 1 presents Linear Sweep Voltammetry (LSV) data illustrating the overpotential pertaining to a Magnéli phase titanium oxide (Ti₄O₇) anode.

In accordance with one or more embodiments, Equations 1 through 5 below may represent the underlying mechanism for electrochemical PFAS removal with a Magnéli phase titanium oxide (Ti₄O₇) anode. The reaction may generally be characterized as a Kolbe-type oxidation. The reaction initiates from direct oxidation of carboxylate ions to carboxylate radicals (Eq. 1) on a Ti₄O₇ surface by applying a sufficient positive voltage. The carboxylate radicals are subsequently decarboxylated to perfluoroalkyl radicals (Eq. 2). By coupling with hydroxyl free radicals which are anodically generated on the Ti₄O₇ surface, the perfluoroalkyl radicals are converted to perfluoro alcohols (Eq. 3) which further defluorinate to perfluoro carbonyl fluoride (Eq. 4) and finally hydrolyze to a perfluorocarboxylic as a byproduct by losing one carbon in the chain (Eq. 5). Reactions 1 to 5 may generally be repeated until all carbon from PFASs are eventually stripped off to inorganic CO₂, H⁺, and F⁻.

Ti₄O₇+C₇F₁₅COO⁻→Ti₄O₇+C₇F₁₅COO·+e⁻ (1)

C₇F₁₅COO·→C₇F₁₅·+CO₂ (2)

C₇F₁₅·+HO·→C₇F₁₅OH (3)

C₇F₁₅OH→C₆F₁₃COF+H⁺+F⁻ (4)

C₆F₁₃COF+H₂O→C₆F₁₃COO⁻+H⁺F⁻ (5)

In accordance with one or more embodiments, various material properties of the Magnéli phase titanium oxide anode may be optimized. For example, a pore structure and/or distribution of the material may be selected in order to promote mass transfer of contaminants for surface reaction as well as to ensure sufficient physical area for reaction. In at least some embodiments, the anode may have a foam structure. In some embodiments, the anode material may have a total porosity of about 25%, 30%, 40%, 50%, 60%, 70% or higher. In at least some embodiments, the total porosity may be about 50% or greater. In some embodiments, the anode material may have a pore size on the micrometer to millimeter scale. In at least some embodiments, the anode material may have a mean pore size ranging from about 100 μm to about 2 mm, i.e. from about 200 μm to about 1.8 mm; 300 μm to about 1.7 mm, 400 μm to about 1.6 mm, or 500 μm to about 1.5 mm. In at least some embodiments, the Magnéli phase titanium oxide may be an anode material commercially available from Magnéli Materials, LLC.

In accordance with one or more embodiments, the Magnéli phase titanium oxide anode may be used in an electrochemical reactor. The anode may be formed in a variety of shapes, for example, planar or circular. In at least some preferred embodiments, the anode may be characterized by a mesh or foam structure, such as may be associated with a higher active surface area, pore structure, and/or distribution.

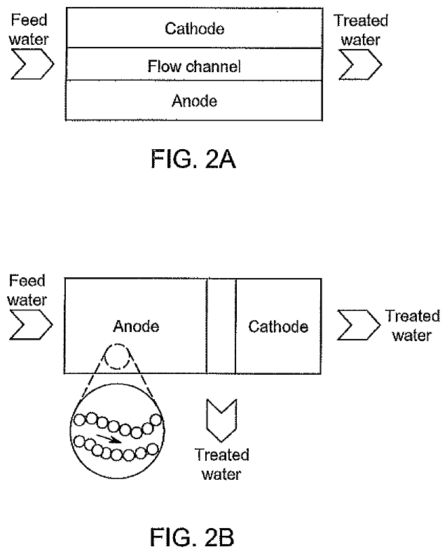

In accordance with one or more embodiments, various reactor flow designs may be implemented. Selection may be based on various operational parameters, for example, based on a concentration of the PFAS in water to be treated. In some embodiments, a flow between electrode (FBE) configuration may be used as illustrated in FIG. 2A. In other embodiments, a flow through electrode (FTE) configuration may be used as illustrated in FIG. 2B. A FBE configuration may be appropriate for relatively high concentrations of PFAS while a FTE configuration may be used for relatively low concentrations of PFAS, such as for drinking water treatment.

In accordance with one or more embodiments, various conventional electrolytes may be used in the electrochemical cell. For example, sodium sulfate may be used as the electrolyte. An electrolyte concentration may impact performance of the electrochemical cell. The electrolyte concentration may be selected in order to minimize the impact of competitive side reactions, for example, water oxidation and/or chlorination on the anode. Thus, the electrolyte concentration may be adjusted in order to maximize the current efficiency of the electrochemical cell with respect to PFAS oxidation. In some non-limiting embodiments, an electrolyte, e.g. sodium sulfate, at a concentration of at least about 5 mM may be used. In at least some non-limiting embodiments, an electrolyte, e.g. sodium sulfate, at a concentration of less than about 100 mM may be used.

Likewise, current density may be a significant operational parameter and may be optimized for electrochemical cell efficiency. Lower current density may require a lower cell voltage with a potential benefit in terms of energy consumption per ppm PFOA removal. However, the overall cell voltage must be sufficient in terms of anode potential in order to oxidize PFASs. According to at least some embodiments, high efficiency while maintaining a high oxidation rate may be achieved by implementing a high surface area anode. A high porosity anode, e.g. a foam anode, may beneficially provide high surface area to introduce high current for PFAS destruction. In some non-limiting embodiments, a current density of about 1-2 mA/cm² may be used. In at least some non-limiting embodiments, a current density of less than about 10 mA/cm² may be used.

In operation, a process stream containing an elevated PFAS level may be introduced to an electrochemical cell for treatment. The electrochemical cell may include a Magnéli phase titanium oxide anode as described herein. The anode material may have a porosity of at least about 25%. The anode material may have a mean pore size ranging from about 100 μm to about 2 mm. The electrochemical cell may include an electrolyte as described herein and a voltage may be applied to the anode as described herein to provide a desired level of treatment. Various pre-treatment and/or post-treatment unit operations may also be integrated. A product stream may be directed to a further unit operation for additional treatment, sent to a point of use, or otherwise discharged. Polarity of the electrochemical cell may be reversed periodically if desired such as to facilitate maintenance.

In accordance with one or more embodiments, one or more sensors may measure a level of PFAS/PFC upstream and/or downstream of the electrochemical cell. A controller 150 may receive input from the sensor(s) in order to monitor PFAS/PFC levels, intermittently or continuously. Monitoring may be in real-time or with lag, either onsite or remotely. A detected PFAS/PFC level may be compared to a threshold level that may be considered unacceptable, such as may be dictated by a controlling regulatory body. Additional properties such as pH, flow rate, voltage, temperature, and other concentrations may be monitored by various interconnected or interrelational sensors throughout the system. The controller may send one or more control signals to adjust various operational parameters, i.e. applied voltage, in response to sensor input.

In accordance with one or more embodiments, a Magnéli phase titanium oxide anode may be fabricated. Various conventional fabrication techniques commonly known to those of skill in the art may be implemented. Current Ti₄O₇ electrodes are generally obtained by oxidation and then reduction of titanium metal at certain temperatures and oxidant levels. The resulting electrode is generally brittle with nonuniform appearance. Thus, its capacity to resist mechanical wearing is limited which directly limits its lifetime for anode applications.

In accordance with one or more non-limiting embodiments, pure Ti₄O₇ powder with a weight percent of about 80% to about 95% may be mixed with a binder comprising PTFE or PVDF. The ratio of metal to plastic binder may be varied depending on factors such as surface affinity towards different liquids. Generally, a hydrophobic surface and lower conductivity may be favored when more binder is added into the electrode/binder mixture.

Prior to electrode fabrication, the Ti₄O₇ powder may be ball milled in order to achieve a desired particle size. The metal powder may be mixed with either PTFE or PVDF. The final electrode can then be fabricated on a titanium substrate by methods such as injection molding, painting, or doctor blading. This invention is not limited by the method of electrode fabrication.

The function and advantages of these and other embodiments will be more fully understood from the following examples. The examples are intended to be illustrative in nature and are not to be considered as limiting the scope of the materials, systems, and methods discussed herein.

### Example 1

Experiments were performed to explore the effect of anode material selection and voltage on defluorination efficiency in an electrochemical cell. A defluorination ratio (%) is a term that may be used to describe the extent to which organic PFAS has been mineralized to release inorganic F⁻. It is the ratio of actual F⁻ detected by instrument after the treatment divided by total F in the original organic PFAS.

Three different types of anode materials were tested: DSA, BDD, and Ti₄O₇. For each test, 80 mL of a feed solution having a 10 ppm PFOA concentration was introduced to a test cell. A 5 mM Na₂SO₄ solution was used as the electrolyte. A 25 mA current was applied over a reaction time of about 20 minutes. The Ti₄O₇ anode was also tested with a 100 mM Na₂SO₄ electrolyte solution.

The related data is presented in Table 1. A higher De-F value (%) indicated better treatment performance. No defluorination was detected with the high concentration electrolyte solution. 3V cell voltage was insufficient to accomplish defluorination with any of the anodes. Ti₄O₇ was a very effective anode, performing competitively with BDD, and would be a viable option for anode material depending on PFAS removal requirements, particularly in view of its robustness, lower cost, and environmental friendliness.

TABLE 1

| | Reaction | Reaction |
|---|---|---|
| | voltage: 3 V | voltage: 5.5 V |
| Ti₄O₇ | F⁻ Not detected | 32% |
| DSA (Pt/Ti, IrO₂/Ti, RuO₂/Ti) | F⁻ Not detected | F⁻ Not detected |
| BDD | F⁻ Not detected | 57% |
| Ti₄O₇ (100 mM Na₂SO₄) | F⁻ Not detected | F⁻ Not detected |

### Example 2

Testing was conducted on Ti₄O₇ anodes at varying PFOA feed concentrations and at varying electrolyte concentrations. The anodes were G1 foam Ti₄O₇ anodes commercially available from Magnéli Materials, LLC. The anodes had a pore size of from about 100 um to about 2 mm. Porosity of the anode was estimated to be about 50%. The anodes had dimensions of about 3×3×0.5 cm and were placed in the test cell at an inter-electrode distance of about 3 cm.

Preliminary tests were performed to determine an appropriate cell voltage for PFOA destruction. The data indicated that F⁻ anion was only capable to be detected at a potential higher than or equal to +4.5V vs. Ag/AgCl (equivalent to 5.1V vs. RHE) in 5 mM Na₂SO₄ electrolyte in a 1-hour experiment. This corresponded to an overall cell voltage of about 6V when the distance between cathode and anode was 3 cm. The cathode used throughout the preliminary experiments was Pt coated titanium.

Thus, in order to promote Kolbe type oxidation, the current for the main experiments was adjusted until the cell voltage was larger than 6V. In this case, 25 mA was applied on the anode while a cell voltage of about 6V was recorded.

The primary tests were performed at room temperature (about 25° C.) and at a neutral pH level (about 6.8-7.2) in a batch process (100 mL beaker). An 80 ml Na₂SO₄ solution without any pH adjustment was used for the electrolyte.

The data is presented in Table 2. The use of a 0.1M electrolyte solution did not result in PFOA removal. The 5 mM electrolyte solution was effective at treating both the low and high PFOA concentration feeds.

Quantification of F⁻ anion was achieved by Ion Chromatography (Metrohm 850 professional IC) coupled with Metrosep A column. The mobile phase was 3.2 mM Na₂CO₃ and 1 mM NaHCO₃. Quantification of PFOA anion was achieved by the same IC, however, employing a ProntoSlL HPLC column and a solution consisting of 10 mM boric acid and 20 wt % acetonitrile (pH was adjusted to 8 by 4M NaOH) as the mobile phase.

The F− recovery data refers to total F− that has been recovered from PFOA and its by-products. In the PFAS destruction process, the voltage of the cell is high enough to remove some F− from water but the F− recovery data is significant in that it demonstrates that PFAS is being destroyed in water. It is also worth noting that the potential higher than 5V vs. RHE is sufficient to convert F− anion to other forms of fluorine (e.g. F₂ gas) which may also have impacted the accuracy of this data.

The associated energy consumption was much higher in connection with the low PFOA concentration feed as mass transport is limited when PFOA concentration is low.

TABLE 2

| | | | | PFOA | |
|---|---|---|---|---|---|
| | | | | removal rate | |
| | | | Percentage of | measured by | |
| | | | PFOA | IC employing | Energy |
| | | | removal | boric acid | consumption/ppm |
| | | Feeding | based on F⁻ | buffer as the | PFOA removal |
| Electrode | Electrolyte | PFOA (ppm) | recovery | middle phase | (kwh/m³/ppm) |
| Ti₄O₇ foam | 5 mM Na₂SO₄ | 50 | 72% | 99% | 2.4 |
| electrode | | | | | |
| from Magneli | | | | | |
| Materials | | | | | |
| Ti₄O₇ foam | 5 mM Na₂SO₄ | 10 | 50% | 99% | 7.2 |
| electrode | | | | | |
| from Magneli | | | | | |
| Materials | | | | | |
| Ti₄O₇ foam | 0.1M Na₂SO₄ | 50 | N.A. | No removal | N.A. |
| electrode | | | | | |
| from Magneli | | | | | |
| Materials | | | | | |

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of treating water containing per- and polyfluoroalkyl substances (PFASs), comprising:
introducing the water to an electrochemical cell comprising a cathode and a Magnéli phase titanium oxide anode having a porosity of at least about 25%; and
applying a voltage to the anode in an amount sufficient to promote oxidation of the PFASs in order to produce treated water.

2. The method of claim 1, wherein the PFASs comprise perfluorooctane sulfonic acid (PFOS) or perfluorooctanoic acid (PFOA).

3. The method of claim 1, wherein the anode comprises TiₙO₂ₙ₋₁, where n ranges from 3 to 9 inclusive.

4. The method of claim 3, wherein the anode comprises Ti₄O₇.

5. The method of claim 1, wherein the anode comprises a foam or a mesh structure.

6. The method of claim 1, wherein the anode comprises a foam structure.

7. The method of claim 6, wherein the foam anode is characterized by a mean pore size of from about 100 μm to about 2 mm.

8. The method of claim 1, wherein the cathode is made of a stainless steel, nickel alloy, titanium, or a dimensionally stable anode (DSA) material.

9. The method of claim 1, wherein the water is circulated between the cathode and the anode.

10. The method of claim 1, wherein the water is circulated through the anode and cathode in series.

11. The method of claim 1, wherein the electrochemical cell comprises a sodium sulfate electrolyte at a concentration of about 5 mM.

12. The method of claim 1, further comprising introducing the treated water to a downstream unit operation for further treatment.

13. The method of claim 1, further comprising monitoring a PFAS concentration, pH level, or other operational parameter upstream of the electrochemical cell.

14. The method of claim 13, further comprising adjusting the applied voltage in response to the monitored PFAS concentration.

15. The method of claim 1, further comprising monitoring a PFAS concentration, pH level, or other operational parameter downstream of the electrochemical cell.

16. A water treatment system, comprising:
an electrochemical cell comprising a Magnéli phase titanium oxide anode having a porosity of at least about 25%; and
a source of water comprising PFASs fluidly connected to an inlet of the electrochemical cell.

17. The system of claim 16, wherein the PFASs comprise perfluorooctane sulfonic acid (PFOS) or perfluorooctanoic acid (PFOA).

18. The system of claim 16, wherein the anode comprises Ti₄O₇.

19. The system of claim 16, wherein the anode comprises a mesh structure.

20. The system of claim 16, wherein the anode comprises a foam structure.

21. The system of claim 20, wherein the foam anode is characterized by a mean pore size of from about 100 μm to about 2 mm.

22. The system of claim 16, wherein the electrochemical cell is constructed and arranged to circulate the water between the cathode and the anode.

23. The system of claim 16, wherein the electrochemical cell is constructed and arranged to circulate the water through the cathode and the anode in series.

24. The system of claim 16, wherein the electrochemical cell further comprises a sodium sulfate electrolyte at a concentration of about 5 mM.

25. The system of claim 16, further comprising at least one concentration, pH or other sensor positioned upstream and/or downstream of the electrochemical cell.

26. The system of claim 25, further comprising a controller in communication with the at least one sensor configured to adjust a voltage applied to the electrochemical cell.

27. The system of claim 16, wherein the anode is characterized by a hydrophobic surface.
